(19) United States
(12) Patent Application Publication
(10) Pub. No.: US 2016/0243998 A1
(43) Pub. Date: Aug. 25, 2016

(54) A Carrier For Mounting To A Vehicle

(71) Applicant: FREELOAD AUTO LIMITED, Dunedin (NZ)

(72) Inventor: Patrick David Maguire, Monaco, Nelson (NZ)

(21) Appl. No.: 15/029,761

(22) PCT Filed: Oct. 17, 2014
(86) PCT No.: PCT/NZ2014/000219

§ 371 Date: Apr. 15, 2016

Related U.S. Application Data
(60) Provisional application No. 61/892,164, filed on Oct. 17, 2013.

(51) Int. Cl. B60R 9/10

(52) U.S. Cl. CPC B60R 9/10

(57) ABSTRACT

This invention relates to a bicycle carrier for mounting to a vehicle. The carrier includes a mounting portion for attaching the carrier to a vehicle, a main member attached to the mounting portion, and a pair of wheel supports affixed relative to the main member and at an angle of between about 35 degrees and about 55 degrees to a substantially horizontal axis, such that upper ends of the wheel supports are closer together than lower ends of the wheel supports. Each wheel support includes a channel for partial receipt of a bicycle wheel. The wheel supports are configured to support the wheels of bicycles having a range of wheel diameters and/or wheel base lengths.

### FIELD OF THE INVENTION

This invention relates to a carrier that is mountable to a vehicle, for example, to the rear of a vehicle on a vehicle hitch or tow-ball.

### BACKGROUND

Carriers are available for externally carrying articles at the rear of an automobile. Such carriers are commonly used for sporting equipment, luggage, or other items that cannot be comfortably or conveniently carried within the vehicle. Rear-mounted carriers typically attach to an automobile's hitch or tow-ball, or strap to a rear door or trunk, and have a number of associated disadvantages.

Carriers mounted to the rear of a vehicle typically impede access to the vehicle back door or trunk. Therefore, rear-mounted carriers commonly need to be unloaded and removed from the vehicle before the rear door or trunk may be accessed, which is inconvenient.

Some carriers have a pivotable carrying member that can be temporarily pivoted down from a vertical in-use position, to a horizontal or near horizontal non-use position for rear vehicle access. Known pivoting carriers typically utilise manual pin and aperture arrangements to manually pin the carrying member in the vertical position. A user must remove a pin from the carrier before pivoting the carrying member away from the vehicle. A second person may need to support the carrying member and load while the pin is removed to prevent the carrying member dropping suddenly to the horizontal orientation and potentially damaging any attached articles and being a safety hazard. In addition, it can be difficult to correctly align the apertures to reinsert the pin when the returning the carrying member to vertical. If the pin member is misplaced, the carrier is inoperable.

Most rear-mounted carriers have only a single in-use carrying configuration. They are not typically adjustable to carry different types or numbers of articles, or adjustable to better accommodate different vehicle types, for example, to be more aerodynamic.

Further, most rear-mounted carriers are specific for carrying one type of article, for example, bicycles. They do not allow two or more different types of articles to be loaded on the carrier at one time.

It is an object of at least preferred embodiments of the present invention to address one or more of the abovementioned disadvantages and/or to at least provide the public with a useful alternative.

In this specification where reference has been made to patent specifications, other external documents, or other sources of information, this is generally for the purpose of providing a context for discussing the features of the invention. Unless specifically stated otherwise, reference to such external documents or such sources of information is not to be construed as an admission that such documents or such sources of information, in any jurisdiction, are prior art or form part of the common general knowledge in the art.

### SUMMARY OF THE INVENTION

According to one aspect of the present invention there is provided bicycle carrier for mounting to a vehicle, the carrier comprising:
a mounting portion for attaching the carrier to a vehicle;
a main member attached to the mounting portion; and
a pair of wheel supports fixed relative to the main member and at an angle of between about 35 degrees and about 55 degrees to a substantially horizontal axis, such that upper ends of the wheel supports are closer together than lower ends of the wheel supports;
wherein each wheel support comprises a channel for partial receipt of a bicycle wheel, and wherein the wheel supports are configured to support the wheels of bicycles having a range of wheel diameters and/or wheel base lengths.

According to the second aspect of the present invention it is provided a bicycle carrier substantially as described above, wherein the wheel supports are fixed relative to the main member at an angle of about 45 degrees to the substantially horizontal axis.

According to the third aspect of the present invention it is provided a bicycle carrier substantially as described above, wherein a portion of each wheel support channel has a cross-sectional curvature corresponding to the curvature of a first selected bicycle tyre and dimensioned to frictionally contact the first selected bicycle tyre.

According to the fourth aspect of the present invention it is provided a bicycle carrier substantially as described above, wherein each wheel support comprises a removable insert defining a channel with a cross-sectional curvature corresponding to the curvature of a second selected bicycle tyre that is narrower than the first selected bicycle tyre and dimensioned to frictionally contact the second selected bicycle tyre.

According to the fifth aspect of the present invention it is provided a bicycle carrier substantially as described above, wherein the base portion of each wheel support channel has a cross sectional radius of curvature of between about 10 mm and about 12 mm, and an upper portion of each wheel support channel has a cross sectional curvature of between about 20 mm and about 30 mm.

According to the sixth aspect of the present invention it is provided bicycle carrier substantially as described above, wherein each wheel support channel comprises an intermediate portion between the respective base portion and upper portion, wherein the intermediate portion has a cross-sectional width of between about 12 mm and about 25 mm and/or a curvature that is less than the curvature of the respective base portion and greater than the curvature of the respective second portion.

According to the seventh aspect of the present invention it is provided a bicycle carrier substantially as described above, comprising a support member for attaching to the frame of a bicycle.

According to the eighth aspect of the present invention it is provided a carrier for mounting to a vehicle, the carrier comprising a mounting portion that is mountable to a vehicle, and a movable support connected to the mounting portion, the support comprising an elongate cross member, and two substantially parallel side members fixed relative to the cross member at or towards opposite ends of the cross member;
wherein each side member comprises two elongate channels on opposite faces of the side member for attaching supplementary carriers to the support; and
wherein the movable support is pivotable about a longitudinal axis of the cross member and is fixable in at least two angular positions relative to the mounting portion.

According to the ninth aspect of the present invention it is provided a carrier substantially as described above, wherein the support is pivotable through at least 180 degrees.

According to the tenth aspect of the present invention it is provided a carrier substantially as described above, wherein the support is fixable in a substantially vertical orientation when the carrier is mounted to a vehicle.

According to the 11th aspect of the present invention it is provided a carrier substantially as described above, wherein the support is fixable in a substantially horizontal orientation when the carrier is mounted to a vehicle.

According to the 12th aspect of the present invention it is provided a carrier substantially as described above, wherein the mounting portion comprises a sleeve and the cross member is rotatable in the sleeve about its longitudinal axis.

According to the 13th aspect of the present invention it is provided a carrier for mounting to a vehicle, the carrier comprising a mounting portion that is mountable to a vehicle, and a movable support connected to the mounting portion, the support comprising an elongate member and two substantially parallel side members fixed relative to the cross member at or towards opposite ends of the cross member;

wherein each side member includes two elongate channels on opposite faces of the side member for attaching supplementary carriers to the support.

According to the 14th aspect of the present invention it is provided a carrier substantially as described above, wherein the elongate member also includes two elongate channels on opposite faces of the side member for attaching supplementary carriers to the support.

According to the 15th aspect of the present invention it is provided a carrier substantially as described above, wherein the movable support is pivotable about a longitudinal axis of the cross member and is fixable in at least two angular positions relative to the mounting portion.

According to the 16th aspect of the present invention it is provided a bicycle carrier for mounting to a vehicle, the carrier comprising:
a mounting portion for attaching the carrier to a vehicle;
a main member attached to the mounting portion;
a pair of angled wheel supports attached to the main member, angled such that upper ends of the wheel supports are closer together than lower ends of the wheel supports; and
an adjustable support for attaching to the down tube of a bicycle, the adjustable support being movable relative to the wheel supports in a longitudinal direction of the adjustable support.

According to the 17th aspect of the present invention it is provided an adjustable vehicle attachment apparatus comprising:
a mounting portion configured for mounting to a vehicle; and
a movable member operatively connected to the mounting portion and movable relative to the mounting portion, one of the mounting portion and the movable member comprising a plurality of engagement features;
the adjustable vehicle attachment apparatus further comprising a latch mechanism provided on the other one of the mounting portion and the movable member, the latch mechanism comprising:
a slidable member having a tracking surface; and
an engagement member configured to follow the tracking surface and movable in a direction perpendicular to the slide direction of the slidable member to engage and disengage different ones of the engagement features;
wherein the movable member is fixable in a plurality of positions relative to the mounting portion by engaging the engagement member with different ones of the engagement features, and wherein the latch mechanism is biased into a configuration for engaging at least one engagement feature.

According to the 18th aspect of the present invention it is provided a carrier tow-ball mounting device, the device comprising:
a mounting housing including side walls and top and floor walls forming an enclosure wherein the floor wall includes an aperture therein, the aperture comprising an enlarged portion that is dimensioned to receive the tow-ball, and a narrow portion with a width that is narrower than the diameter of the tow-ball; and
a clamp having a movable jaw that is linearly movable within the housing,
wherein the movable jaw is movable to clamp the tow-ball between the movable jaw and a wall of the housing when the tow-ball is positioned in the housing above the narrow portion of the aperture, and wherein the movable jaw has a surface with a curvature corresponding to the curvature of the tow-ball and/or wherein the movable jaw is configured to contact a plurality of points on the tow-ball.

In preferred embodiments, the engagement features are provided on the mounting portion and the latch mechanism is provided on the movable member, and configured such that the slidable member is slidable in a longitudinal direction of the movable member.

The engagement features preferably comprise recesses or apertures.

In an embodiment, the movable member comprises a longitudinal axis and is rotatable about its longitudinal axis.

The slidable member is preferably slidable between an engagement position that enables movement of the engagement member into engagement with one of the engagement features, and a disengaged position that prevents engagement between the engagement member and the engagement features. The slidable member is preferably biased into its engagement position. In an embodiment, the engagement position is a middle position of the slidable member, and the latch mechanism comprises two opposed biasing members to bias the slidable member to the middle engagement position.

The carrier may comprise a slidable actuator operably connected to the slidable member, for sliding the slidable member from its engaged position to its disengaged position. Preferably, the carrier comprises two slidable actuators comprising two handles disposed on the movable member at or towards opposite ends of the slidable member, wherein the slidable member is slidable from its engaged position to its disengaged position using either one of the two handles.

In an embodiment, the cam surface comprises a first surface portion and a second surface portion spaced from the first surface portion in a direction perpendicular to the slide direction of the slidable member. The slidable member preferably comprises a slot, and a surface of the slot provides the cam surface.

The latch mechanism may comprise a pair of engagement members that are oppositely movable towards and away from each other. In an embodiment, the slidable member comprises a slot having a wide portion and a narrow portion and two opposed surfaces, wherein one engagement member is configured to follow each surface.

Alternatively or additionally, the latch mechanism may comprise two spaced apart engagement members.

In an embodiment, the latch mechanism comprises two spaced apart pairs of engagement members, the engagement members in each pair being oppositely movable towards and away from each other. The slidable member may comprise two slots each having a wide portion and a narrow portion and two opposed surfaces, wherein when one engagement member is configured to follow each surface.

In a preferred embodiment, the carrier comprises two rows of engagement features. The two rows of engagement features may be offset from each other.

Preferably, each engagement member is biased outwards from the slidable member, towards an engagement position for engaging the engagement features.

In a preferred embodiment, the mounting portion comprises a sleeve and the movable member is movable in the sleeve. In some embodiments, the movable member is rotatable in the sleeve, and the engagement features comprise at least one row of circumferentially disposed apertures or recesses on the sleeve.

The carrier may comprise a plastic bearing component between the movable member and the sleeve, which is configured to rotate with the movable member and bear against an inner surface of the sleeve. Friction between the bearing component and the sleeve resists rotation of the movable member relative to the sleeve.

In an embodiment, the movable member comprises an elongate extruded member having a channel along each side of the member.

The carrier preferably comprises a mount member for mounting to the rear of a vehicle, the mounting portion being fixed relative to the mount member. In some embodiments, the mount member is configured for mounting to a vehicle tow-ball. In alternative embodiments, the mount member is configured for mounting to a tubular hitch.

The carrier comprises a mounting portion that is mountable to a vehicle, and a movable support connected to the mounting portion, the support comprising an elongate cross member, and two substantially parallel side members fixed relative to the cross member at or towards opposite ends of the cross member. Each side member comprises two elongate channels on opposite faces of the side member for attaching supplementary carriers to the support. The movable support is pivotable about a longitudinal axis of the cross member and is fixable in a plurality of angular positions relative to the mounting portion.

The carrier comprises a mounting portion for attaching the carrier to a vehicle, a main member attached to the mounting portion, and a pair of wheel supports fixed relative to the main member and at an angle of between about 35 degrees and about 55 degrees to a substantially horizontal axis, such that upper ends of the wheel supports are closer together than lower ends of the wheel supports. Each wheel support comprises a channel for partial receipt of a bicycle wheel. The wheel supports are configured to support the wheels of bicycles having a range of wheel diameters and/or wheel base lengths.

The wheel supports are preferably fixed relative to the main member at an angle of about 45 degrees to the substantially horizontal axis.

In preferred embodiments, the wheel supports are fixed relative to the main member and are angled between about 35 degrees and about 55 degrees to a substantially horizontal axis. In an embodiment, the wheel supports are at an angle of about 45 degrees to the substantially horizontal axis.

In preferred embodiments, the wheel supports are configured to enable a bike having its wheels in the wheel supports to be freestanding.

In an embodiment, a portion of each wheel support channel has a cross-sectional curvature corresponding to the curvature of a first selected bicycle tyre and dimensioned to frictionally contact the first selected bicycle tyre. Each wheel support may comprise a removable insert defining a channel with a cross-sectional curvature corresponding to the curvature of a second selected bicycle tyre that is narrower than the first selected bicycle tyre and dimensioned to frictionally contact the second selected bicycle tyre.

Each wheel support channel may comprise an intermediate portion between the respective base portion and upper portion, wherein the intermediate portion has a cross-sectional width of between about 12 mm and about 25 mm and/or a curvature that is less than the curvature of the respective base portion and greater than the curvature of the respective second portion.

Each wheel support may comprise an elastomeric strap for securing a bicycle wheel in the wheel support. Each wheel support may comprise a plurality of contact features for securing the elastomeric strap at alternative positions along the respective wheel support.

The bicycle carrier may further comprise a support member for attaching to the frame of a bicycle. The support member is preferably a support member for supporting the down tube of a bicycle.

In an embodiment, the carrier comprises two or more pairs of wheel supports for supporting two or more bicycles. The two or more pairs of wheel supports may be substantially parallel. Preferably each wheel support is at an angle of about 45 degrees to a substantially horizontal axis.

In some embodiments, the mounting portion is configured for mounting to a vehicle tow-ball. Alternatively, the mounting portion may be configured for mounting to a tubular hitch. Preferably the main member is movable relative to the mounting portion. For example, the main member may be rotatable relative to the mounting portion about a longitudinal axis of the main member.

The adjustable support may be telescopically adjustable.

In an embodiment, at least one of the wheel supports comprises a receiver for receiving the adjustable support. Preferably each wheel support comprises a receiver for receiving the adjustable support, the adjustable support being removable from one receiver and movable into the other receiver to accommodate differently orientated bicycles. In an embodiment, each receiver forms an angle with the horizontal axis that is substantially the same as the angle of the respective wheel support to the horizontal axis.

The or each receiver may comprise a collar that can be tightened to clamp the adjustable support and fix the position of the adjustable support relative to the respective receiver and that can be loosened to enable adjustment of the adjustable support or removal of the adjustable support from the respective receiver. In an embodiment, the collar comprises a cam lever.

Each wheel support may comprise straps for securing a bicycle wheel to the respective wheel support. The adjustable support may comprise a strap for securing the adjustable support to the down tube of a bicycle.

In some embodiments, the mounting portion is configured for mounting to a vehicle tow-ball. Alternatively, the mounting portion may be configured for mounting to a tubular hitch.

The clamp preferably comprises a fixed jaw that is fixed relative to the housing, and the movable jaw is movable towards and away from the fixed jaw. The fixed jaw preferably comprises a surface with a curvature corresponding to the curvature of the tow-ball and/or is configured to contact a plurality of points on the tow-ball. The fixed jaw may comprise a recess in an end wall of the housing.

In an embodiment, the clamp comprises a threaded member and the housing comprises a complementary threaded aperture, and wherein rotation the threaded member adjusts the position of the movable jaw relative to the housing.

The term ‘comprising’ as used in this specification and claims means ‘consisting at least in part of’. When interpreting statements in this specification and claims which include the term ‘comprising’, other features besides the features prefaced by this term in each statement can also be present. Related terms such as ‘comprise’ and ‘comprised’ are to be interpreted in a similar manner.

It is intended that reference to a range of numbers disclosed herein (for example, 1 to 10) also incorporates reference to all rational numbers within that range (for example, 1, 1.1, 2, 3, 3.9, 4, 5, 6, 6.5, 7, 8, 9 and 10) and also any range of rational numbers within that range (for example, 2 to 8, 1.5 to 5.5 and 3.1 to 4.7) and, therefore, all sub-ranges of all ranges expressly disclosed herein are hereby expressly disclosed. These are only examples of what is specifically intended and all possible combinations of numerical values between the lowest value and the highest value enumerated are to be considered to be expressly stated in this application in a similar manner.

This invention may also be said broadly to consist in the parts, elements and features referred to or indicated in the specification of the application, individually or collectively, and any or all combinations of any two or more said parts, elements or features, and where specific integers are mentioned herein which have known equivalents in the art to which this invention relates, such known equivalents are deemed to be incorporated herein as if individually set forth.

As used herein the term ‘(s)’ following a noun means the plural and/or singular form of that noun.

As used herein the term ‘and/or’ means ‘and’ or ‘or’, or where the context allows both.

The invention consists in the foregoing and also envisages constructions of which the following gives examples only.

### BRIEF DESCRIPTION OF THE DRAWINGS

The present invention will now be described by way of example only and with reference to the accompanying drawings in which:

FIG. 1 is a rear perspective view of a preferred embodiment carrier for mounting to a vehicle tow-ball, with the H-shaped support in a vertical orientation;

FIG. 2 is an exploded perspective view of the carrier of FIG. 1 showing the latch adjustment mechanism;

FIG. 3 is a partial front hidden detail view of the carrier of FIGS. 1 and 2, showing the latch adjustment mechanism in its engagement mode;

FIGS. 4(i) and 4(ii) are partial front elevation views of the engagement members and the slidable member, showing the movement of the engagement members between a retracted position in FIG. 4(i) and an engaged position in FIG. 4(ii);

FIGS. 5(i) to 5(iii) are side elevation views showing the H-shaped support of the carrier of FIGS. 1 to 3 being pivoted from a horizontal orientation in FIG. 5(i) to an intermediate angled orientation in FIG. 5(ii), to a vertical orientation in FIG. 5(iii);

FIGS. 6(i) to 6(iv) are side elevation views of an article and supplementary carrier loaded on the carrier of FIGS. 1 to 5(iii), showing the carrier mounted on different types of automobiles in different orientations, where FIG. 6(i) shows the carrier and article mounted in an angled upright orientation on a van, FIG. 6(ii) shows the carrier and article mounted in an angled upright orientation on a sports utility vehicle, FIG. 6(iii) shows the carrier in a horizontal orientation on a sedan with the article mounted transversely between the side members, and FIG. 6(iv) shows the carrier and article mounted an angled upright orientation on a station wagon or hatchback, with the long ends of the side members below the cross member to lower the height of the article;

FIGS. 7(i) to 6(iv) are rear elevation views showing the carrier of FIGS. 1 to 5(iii) mounted on different types of automobile, where FIG. 7(i) shows the H-shaped support in a vertical orientation, with a supplementary carrier and an article vertically mounted to the right side member, FIG. 7(ii) shows the H-shaped support in a horizontal orientation, with a supplementary carrier and article transversely mounted between the two side members, FIG. 7(iii) shows the H-shaped support in a vertical orientation, with a supplementary carrier and an article transversely mounted between the two side members, and FIG. 7(i) shows the carrier mounted in a vertical orientation with the article removed;

FIGS. 8(i) and 8(ii) show supplementary bicycle carriers attached to the carrier of FIGS. 1 to 8(ii), where FIG. 8(i) shows a supplementary bicycle carriers having a main member mounted transversely between the two side members, and FIG. 8(ii) shows an arrangement having individual wheel supports directly mounted to the carrier side members and a down tube support mounted to the carrier cross member;

FIGS. 9(i) and 9(ii) show the mounting portion for mounting the carriers of FIGS. 1 to 8(iii) to a vehicle tow-ball, where FIG. 9(i) is a rear elevation view of the mounting portion, and FIG. 9(ii) is an underside perspective view;

FIGS. 10(i) to 10(iv) show the mounting portion of FIGS. 9(i) and 9(ii) and operation of the tow-ball clamp, where FIG. 10(i) is a rear view of the mounting portion mounted to a tow-ball, FIG. 10(ii) is a plan view corresponding to 10(i) showing the clamp unclamped, FIG. 10(iii) is a right side section view corresponding to FIG. 10(ii), and FIG. 10(iv) is a right side section view of the mounting portion mounted to a tow-ball, showing the clamp clamped to the tow-ball to secure the mounting portion to the vehicle;

FIGS. 11(i) to 11(iv) show the mounting portion tow-ball housing, where FIG. 11(i) is an underside view of the assembled housing showing the aperture for receiving the tow-ball, FIG. 11(ii) is a rear view of the housing, FIG. 11(iii) corresponds to FIG. 11(i) but shows the two parts of the housing prior to joining the parts to assemble the housing, and FIG. 11(iv) is a right side section view taken along a mid plane of 11(iii);

FIGS. 12(i) to 12(iii) show an alternative form H-shaped carrier for mounting to a tubular hitch on a vehicle, where FIG. 12(i) is a right side elevation view of the carrier with the H-shaped support in a vertical orientation, FIG. 12(ii) is a plan view corresponding to FIG. 12(i), and FIG. 12(iii) is a rear elevation view corresponding to FIGS. 12(i) and 12(iii).

FIGS. 13(i) to 13(iv) show an alternative form platform-type carrier mounted to a vehicle tow-ball, where FIG. 13(i) is a right side elevation view of the carrier with the platform in a horizontal orientation, FIG. 13(ii) is a rear elevation view corresponding to FIG. 13(i), FIG. 13(iii) is a plan view corresponding to FIGS. 13(i) and 13(ii), and FIG. 13(iv) is a right side elevation view of the carrier with the platform in a vertical non-use orientation.

FIG. 14 is a rear elevation view of a further alternative form carrier mounted to a vehicle tow-ball and suitable for carrying bicycles;

FIG. 15 is a rear elevation view of a preferred form bicycle carrier for attaching to a vehicle hitch or tow-ball;

FIG. 16 is a rear elevation partial cut-away view of the bicycle carrier of FIG. 15, showing the latch adjustment mechanism;

FIG. 17 is an enlarged rear elevation view of the right side of the carrier of FIGS. 15 and 16, showing the right wheel support with a bicycle down tube support telescopically attached to the wheel support;

FIG. 18 is a rear schematic view of an alternative form bicycle carrier according to the present invention, comparing two differently sized bicycles resting on the carrier;

FIGS. 19(i) and 19(ii) show one of the wheel supports of the bicycle carrier of FIGS. 15 to 17, where FIG. 19(i) is a front view of the wheel support, and FIG. 19(ii) is an end view of the wheel support;

FIGS. 20(i) to 20(iii) show the wheel support of the bicycle carrier of FIGS. 19(i) and 19(ii), where FIG. 20(i) is an end view of the wheel support schematically showing different sized bicycle tyres supported in the wheel support, FIG. 20(ii) is a front elevation view of the wheel support, and FIG. 20(iii) is a rear elevation view of the wheel support;

FIGS. 21(i) to 21(iii) are a cross-sectional views of a preferred form wheel support supporting bicycle tyres of different widths, where FIG. 21(i) shows the wheel support supporting a wide tyre such as a mountain bike tyre, FIG. 21(ii) shows the wheel support supporting a medium width tyre such as a tyre for a touring or commuting bicycle, and FIG. 21(iii) shows the wheel support supporting a narrow tyre such as a road bike tyre;

FIGS. 22(i) to 22(iii) are cross-sectional views of an alternative form wheel support supporting bicycle tyres of different widths, where FIG. 22(i) shows the wheel support supporting a wide tyre such as a mountain bike tyre, FIG. 22(ii) shows the wheel support with an insert for supporting a medium width tyre such as a tyre for a touring or commuting bicycle, and FIG. 22(iii) shows the wheel support with an alternative insert for supporting a narrow tyre such as a road bike tyre;

FIG. 23 is a rear schematic view of a bicycle supported on the bicycle carrier of FIGS. 15 to 17, showing the down tube support extending from the right wheel support and strapped to the bicycle's down tube;

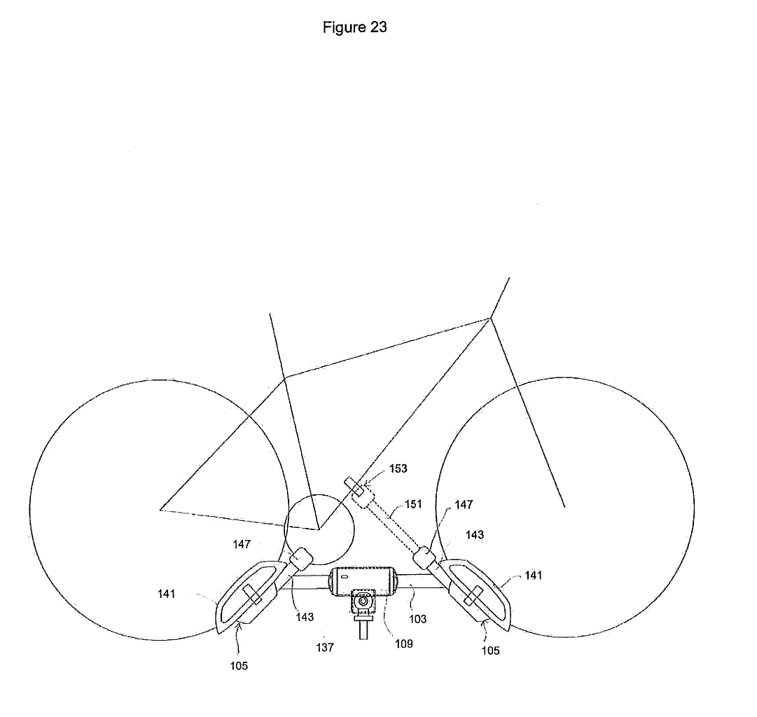

FIGS. 24(i) and 24(ii) are rear schematic views showing a bicycle mounted in two alternative orientations, where FIG. 24(i) shows the bicycle facing left with the down tube support member attached to the left wheel support, and FIG. 24(ii) shows the bicycle facing right with the down tube support member attached to the right wheel support;

FIGS. 25(i) to 25(iv) show details of the attachment between the bicycle down tube and the down tube support, where FIG. 25(i) is plan view of the elastomeric attachment strap, FIG. 25(ii) is a front elevation view of the down tube support with the strap removed, schematically showing two differently sized down tubes resting on the support, FIG. 25(iii) is a cross section view of the down tube support with the strap extending around a down tube, schematically showing two differently sized down tubes resting on the support for comparison, and FIG. 25(iv) is a rear elevation view corresponding to FIG. 25(i); and

FIG. 26 is a rear perspective view of an alternative embodiment bicycle carrier for carrying up to three bicycles, attached to the hitch of a vehicle.

### DETAILED DESCRIPTION OF A PREFERRED EMBODIMENT

Rotatable H-Rack/Latch Mechanism

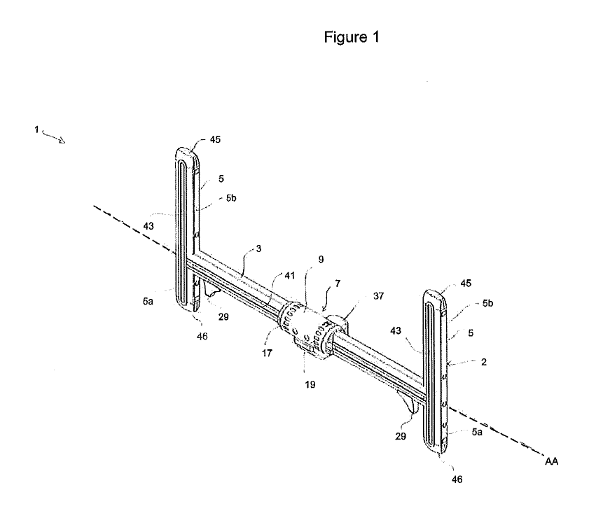

FIGS. 1 to 8(ii) show a preferred form carrier 1 for mounting to the tow-ball 55 of an automobile 51. The carrier 1 comprises an elongate, horizontal cross member 3, and two substantially parallel side members 5 fixed to opposite ends of the cross member 3 to form an H-shaped support 2. The carrier 1 has a mounting portion 37 for attaching to a towing fixture of a vehicle and in the form of a tow-ball 55, and a fixed sleeve 9 that receives the cross member 3. Alternatively, the mounting portion could be configured for mounting to a tubular hitch. The H-shaped support is operatively connected to the mounting portion 37 and is pivotable relative to the mounting portion 37 by rotating the cross member 3 in the sleeve 9 about a longitudinal axis AA of the cross member 3.

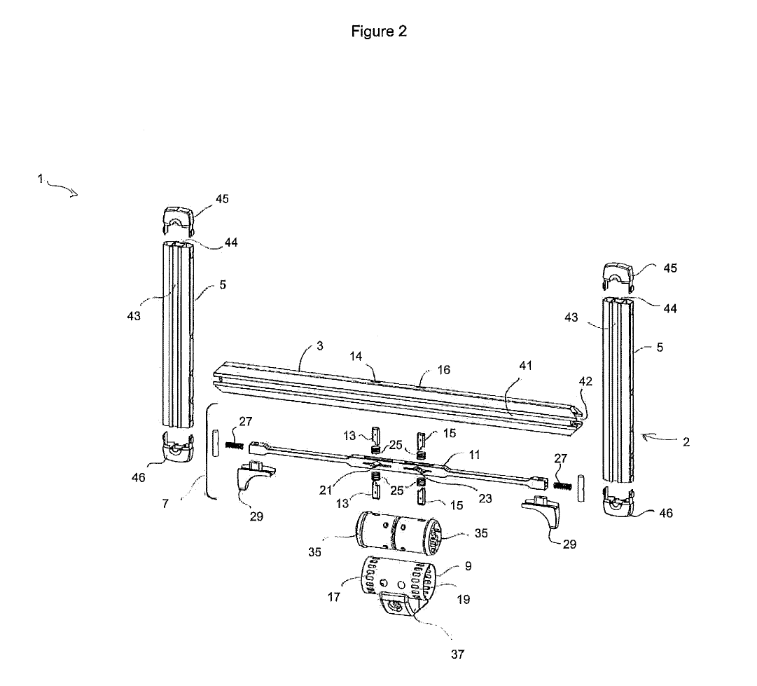

The carrier 1 comprises a latch mechanism 7, shown in FIGS. 2 to 4, for adjusting the carrier 1 by adjusting the orientation of the H-shaped support 2 between a plurality of predefined positions relative to the mounting portion 37. The latch mechanism 7 is largely contained within the cross member 3, and comprises a slidable member 11 that is constrained to be slidable in both directions along the longitudinal axis AA of the cross member 3. Two spaced apart pairs of opposed engagement members 13, 15 are movably attached to the slidable member 11. Part of each engagement member 13, 15 is positioned through a respective aperture 14, 16 in the cross member 3 constraining movement of the engagement members 13, 15 to a direction perpendicular to the longitudinal axis AA.

The slidable member 11 comprises two slots 21, 23 each having narrow first and second ends 21a, 23a, and a wider middle portion 21b, 23b. Each engagement member 13, 15 comprises a roll pin 31 positioned in a respective slot 21, 23. The position of the roll pins 31 relative to the slots 21, 23 changes as the slidable member 11 is slid along the longitudinal axis AA as the engagement members are constrained by the cross member apertures 14, 16 and unable to move longitudinally relative to the cross member 3.

Biasing devices in the form of compression springs 25 on the engagement members 13, 15 act between the slidable member 11 and a protrusion or pin 33 on each engagement member 13, 15 to bias the engagement members 13, 15 outwards from the slidable member 11, towards the sleeve 9. Each slot's opposed surfaces 22a, 22b, 24a, 24b provide tracking surfaces that the roll pins 31 are biased to follow, with the possible outwards movement of the engagement members 13, 15 depending on the position of the roll pins 31 along the slots.

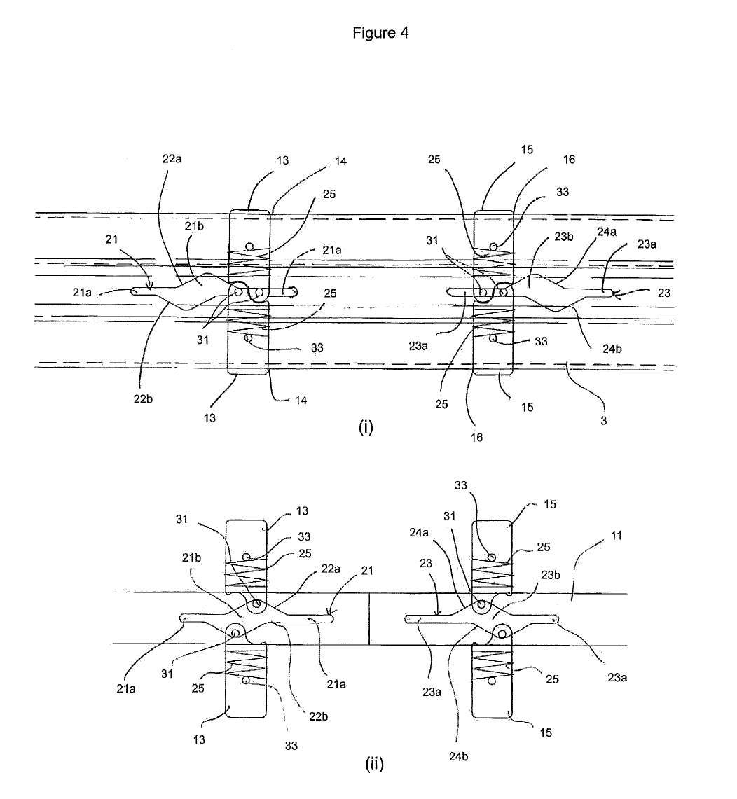

When the pins 31 are positioned at one of the narrow slot ends 21a, 23a, the engagement member pairs 13, 15 are held together and unable to move outwards—see FIG. 4(i). In this configuration, the engagement members are retracted and do not protrude beyond the cross member apertures 14, 16. When the roll pins 31 are positioned in the wide part of the slot 21b, 23b, the engagement members 13, 15 are biased to move apart and outwards relative to the slidable member 11 to potentially protrude through the apertures 14, 16 in a direction perpendicular to the longitudinal axis AA—see FIG. 4(ii).

The sleeve 9 comprises two annular spaced apart rows of circumferentially arranged engagement apertures 17, 19 for receiving the engagement members 13, 15.

With the roll pins 31 in the wide slot portions 21b, 23b, the engagement members are only able to move outwards when cross member 3 is rotated so that the engagement member 13, 15 is aligned with a respective engagement aperture 17, 19. If at least one engagement aperture 17, 19 is aligned with one of the engagement members 13, 15, that engagement member will engage the aperture to lock the orientation of the H-shaped support relative to the sleeve 9. Only one of the engagement members 13, 15 needs to engage an engagement aperture 17, 19 to lock the position of the H-shaped support relative to the carrier.

Alternatively, if no engagement apertures 17, 19 are aligned with an engagement member 13, 15 when the handle 29 is released, the engagement members 13, 15 are prevented from moving outwards by the inner surface of the sleeve, and the roll pins 31 are out of contact with their respective tracking surface 22a, 22b, 24a, 24b. In this configuration, the H-shaped support remains rotatable relative to the sleeve 11. When the H-shaped support is rotated to an orientation where at least one engagement aperture 17, 19 is aligned with one of the engagement members 13, 15, that engagement member will automatically move outwards to engage the aligned aperture and lock the orientation of the H-shaped support relative to the sleeve 9.

When the slidable member 11 is slid to the left or right via handles 29, the roll pins 31 are positioned in the narrow portions 21a, 23a of the slots and the engagement members 13, 15 are retracted and disengaged from the apertures.

In the embodiment shown, each roll pin 31 is offset towards one side of the respective engagement member 13, 15. The facing ends of the engagement members 13, 15 in each pair are shaped so that the when the roll pins 31 are positioned in the narrow portions 21a, 23a of the slots, the ends of engagement members in each pair 13, 15 overlap and the roll pins 31 are positioned side-by-side. This enables the engagement members 13, 15 to be retracted more than if the roll pins 31 were centrally positioned and the ends of the engagement members 13, 15 could not overlap. This advantageously enables a smaller width slidable member 11.

The slots 21, 23 are shaped to accommodate the offset roll pins 31, by offsetting the apex of each tracking surface 22a, 22b, 23a, 23b, which the roll pins 31 abut when the engagement members 13, 15 are in engagement with a respective engagement aperture 17, 19.

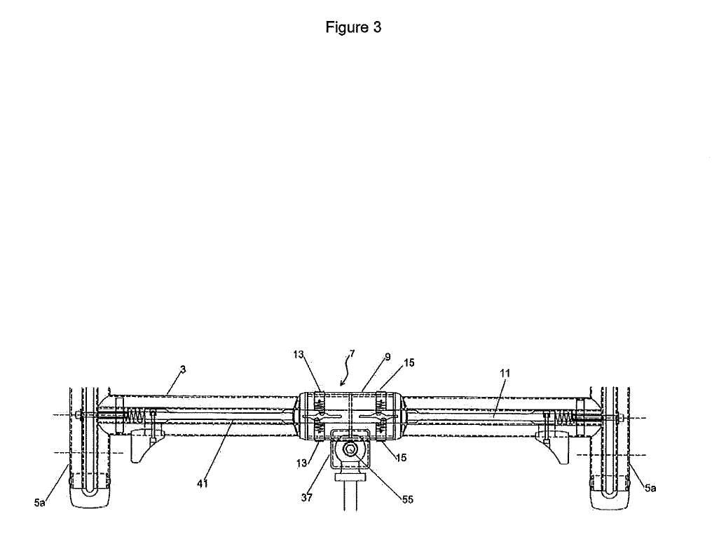

The engagement members 13, 15 are only able to engage a respective engagement aperture when the slidable member 11 is centrally positioned along the longitudinal axis AA, relative to the cross member, as shown in FIG. 3. In that central position, the engagement members roll pins 31 are positioned in the wide portion 21b, 23b of their respective slot 21, 23.

Two biasing devices in the form of compression springs 27 at either end of the slidable member 11 act between the slidable member and the H-shaped support to bias the slidable member to its central engagement position, as shown in FIG. 3. A handle 29 is attached at or towards each end of the slidable member 11 and protrudes out of the cross member 3. A user can slide either handle 29 left or right along the cross member 3 to retract and disengage the engagement members 13, 15 from the engagement apertures 17, 19. When the user releases the handle 29, the biased slidable member 11 returns to its central position.

While the latch 7 comprises two handles 29, the latch 7 is operable with one hand, using either one of the handles 29. This enables a user to disengage and rotate the H-shaped support 2 from one side of the carrier 1. It also advantageously allows a user to support and rotate the H-shaped support 2 with their other hand. Alternatively, the carrier 1 may comprise only a single handle or actuator.

Rather than being provided on the cross member 3, the handles 29 or an alternative actuator may be provided on another part of the support 2. For example, a handle could be provided on one of the side members and connected to the slidable member 11 by way of a cable.

In the embodiment shown, each row of engagement apertures 17, 19 comprises an even number of evenly spaced apertures. This ensures that both of the engagement members in given a pair 13, 15 will be either engaged or disengaged with opposite apertures in the respective row of apertures 17, 19, in all orientations of the H-shaped support 2.

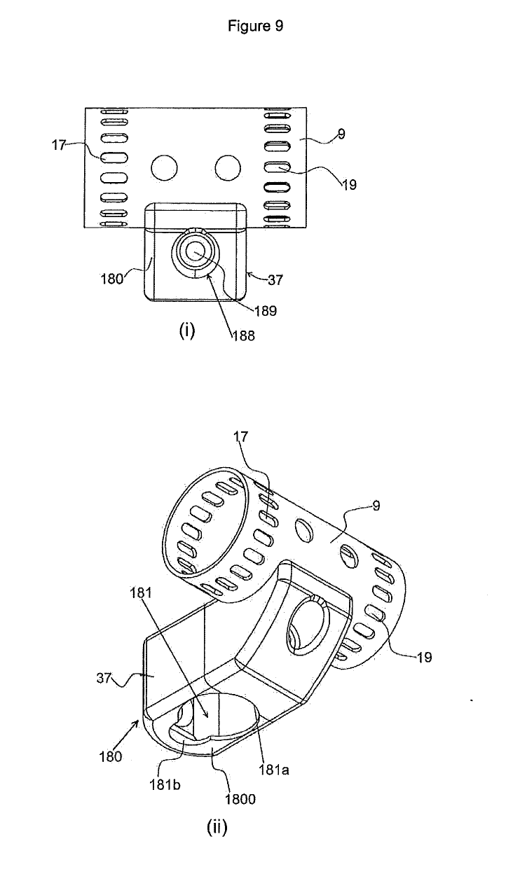

In the embodiment shown, each row of engagement apertures 17, 19 comprises an even number of evenly spaced apertures. Each annular row 17, 19 contains the same number of apertures. However, the rows are offset from each other (see also FIG. 9(i)). Therefore, it is only possible for the engagement members in one pair 13, 15 to engage engagement apertures 17, 19 at any one rotational position of the H-shaped support. Engagement members in the other pair 13, 15 will be disengaged when one pair 13, 15 is engaged.

For example, in one orientation of the support, the engagement members 13 in the first pair engage opposite engagement apertures 17 in the sleeve 9, but the engagement members 15 in the other pair remain retracted any biased against the inner surface of the sleeve 9. However, in an alternative orientation of the H-shaped support, the engagement members 15 in the second pair may engage opposite engagement apertures 19 in the sleeve 9, while the engagement members 13 in the first pair remain retracted and biased against the inner surface of the sleeve 9.

This offset configuration provides twice the number of pre-defined rotational orientations for the H-shaped support than if the two rows of apertures were aligned. For example, in the embodiment shown, each row 17, 19 of engagement apertures comprises 16 apertures at 22.5 degree spacing. The H-shaped support is, therefore, adjustable to 32 rotational orientations in about 11.25 degree increments. However, if the rows were not offset, the support 2 would only be adjustable to 16 rotational orientations in 22.5 degree increments. Providing 32 apertures in a single row to provide the same adjustment resolution with a single row of apertures would require smaller apertures and/or smaller spaces between the apertures, compromising the strength of the engagement.

The number and configuration of the engagement apertures 17, 19 described above is exemplary only, and the sleeve may comprise more or fewer engagement features in varying configurations. For example the sleeve 9 may comprise only one row of engagement features, or may comprise three or more rows. The rows may be aligned or unaligned.

For example, in one alternative embodiment, each row of engagement apertures 17, 19 may comprise an odd number of evenly spaced apertures. In such an embodiment, only one of the engagement members in each pair 13, 15 is able to engage engagement apertures 17, 19 at any one rotational position of the H-shaped support. If the two rows are aligned, one engagement member in each pair 13, 15 will engaged with a respective aperture, and the other engagement member in each pair 13, 15 will be disengaged when the support 2 is fixed relative to the sleeve 9.

Similarly, the latch may comprise more or fewer engagement members. For example the latch may comprise only a single engagement member, or two single spaced apart engagement members. Alternatively, the latch may comprise more than four engagement members.

The sleeve is described as having apertures 17, 19 to receive the engagement members. Alternatively, the engagement features may comprises recesses provided on the inner surface of the sleeve. Such an embodiment would advantageously prevent dirt entering the latch mechanism and bearing arrangement through the aperture, and would also conceal the engagement between the engagement members 13, 15 and the apertures providing safety and aesthetic advantages.

In a further alternative, the latch mechanism could be operatively provided on the mounting portion, and the apertures or other engagement features could be provided on the movable support portion.

The latch mechanism 7 further comprises bearing components 35 that attach to the cross member 3 and are configured to tightly bear against the inner surface of the sleeve 9 and fixed to the cross member 3 to rotate with the cross member and the latch mechanism 7. The slidable member 11 extends through the bearing components 35, and the bearing components 35 have apertures aligned with the apertures 14, 16 on the cross member 3, through which the engagement members 13, 15 can extend. In a preferred embodiment, the bearing components 35 are plastic components. However, the bearing components may alternatively be metal or composite components.

The friction between the bearing components 35 and the sleeve 9 resists the rotation of the cross member 3. This advantageously prevents the H-shaped rack dropping heavily from a near-vertical orientation to a horizontal or downwardly angled orientation under its own weight when the engagement members 13, 15 are retracted. Preferably, the friction between the plastic components 35 and the sleeve 9 is sufficient that the unloaded H-shaped rack is self supporting at any rotational orientation with the engagement members 13, 15 disengaged, but low enough that a user can easily overcome the resistance by applying a rotational force to the H-shaped support 2 with one hand.

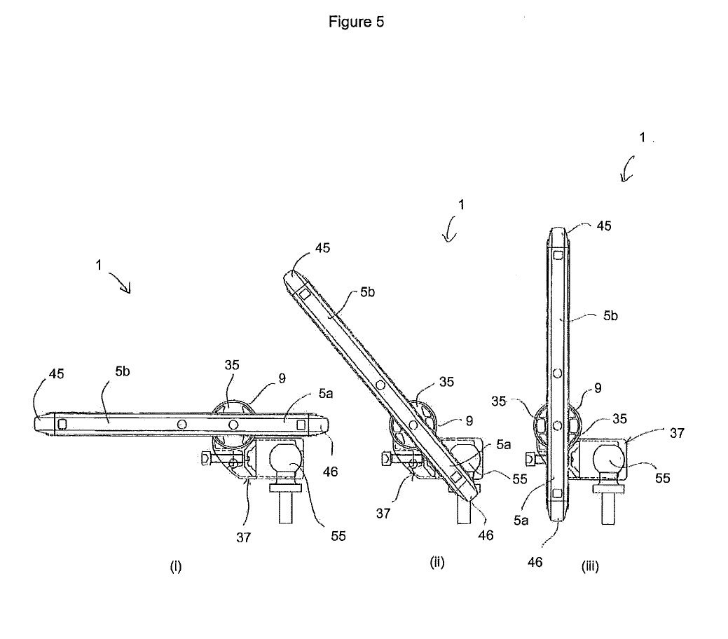

The H-shaped support 2 is pivotable through at least 90 degrees, preferably through at least 180 degrees, and more preferably through 360 degrees. FIGS. 5(i) to 5(iii) illustrate the carrier 1 mounted to the tow-ball 55 of a vehicle (not shown), and fixed in three exemplary orientations. The carrier 1 is mounted with the mounting portion 37 fixed to the vehicle tow-ball 55 and the cross member 3 substantially horizontal and extending transversely relative to the vehicle 51. The H-shaped support 2 is pivotable relative to the vehicle and able to support articles for transportation in each of the rotational orientations.

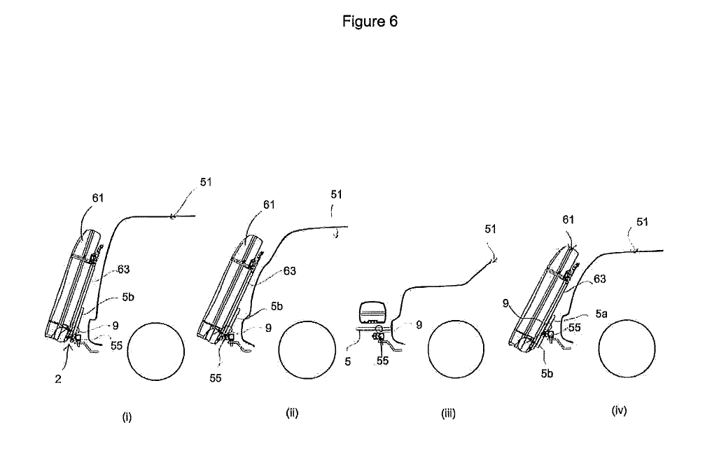

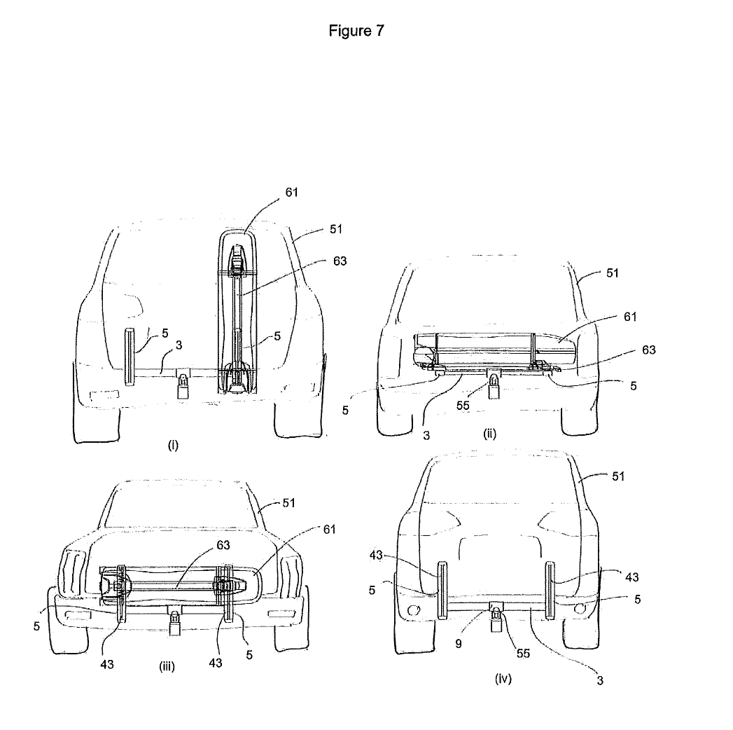

The relatively fine angular adjustment of the H-shaped support 2 that is possible allows adjustment of the carrier 1 to better fit a wide range of vehicles, for example for improved aerodynamics. FIGS. 6(i) to 7(iv) show the carrier mounted to a variety of automobile types 51. A supplementary carrier 63 is shown mounted to the carrier 1 with a wheeled case 61 attached to the supplementary carrier 63 for illustrative purposes. These images show that the carrier 1 may be adjusted to a more upright configuration when mounted to a vehicle with a relatively upright back end, for example a van (FIG. 6(i)). Alternatively the carrier may be angled forward for vehicles such as sports utility vehicles, hatch backs and station wagons that have more forward sloping back ends, as shown in FIGS. 6(ii) and 6(iv), for improved aerodynamics and aesthetics.

H-Shaped Support

In addition, the H-shaped support 2 is asymmetric about the longitudinal axis AA of the cross member 3, with each side member 5 having a short end 5a and a long end 5b. In the embodiments shown in FIGS. 6(i) and 6(ii), the carrier is oriented with its long ends 5b above the cross member 3. However, the carrier 1 may alternatively be oriented with the side member long ends 5b below the cross member 3, as shown in FIG. 6(iv). This alternative configuration may be advantageous for mounting tall articles to lower profile vehicles, to minimise the height that the articles protrude above the vehicle.

In the embodiment shown, the side members 5 are of a fixed length and are fixed to the cross member 5. Alternatively, the side members 5 may be extendible, for example telescopically, or may be interchangeable with different length side members.

Each side member 5 comprises an extrusion having two opposed elongate channels 43, 44, for attaching supplementary carriers to the side members 5. The cross member 3 similarly comprises an extrusion having opposed elongate channels 41, 42. The opposed elongate channels 41, 42, 43 and 44 are preferably in the form of T-slots.

Each channel 41, 42, 43, 44 has two opposed lips. Supplementary carriers may be clamped or bolted to the bar, the lips of the each channel catching the bolt or a portion of the clamp in the channel. A bolt or clamp may be placed into one of the channels 41, 42, 43, 44 from an end of the channel, and slid along the channel to the desired position. Tightening the bolt or clamp clamps the channel lips to fix its position along the channel and secure a supplementary carrier to the carrier 1 as it known in the art.

End caps 45, 46 may be attached to the ends of the side members 5 to cover sharp end edges, protect the ends of the side members, and to prevent supplementary carriers or other attachments falling out from the attachment channels 43, 44.

Having channels 41, 42, 43, 44 on both sides of the side members 5 enables supplementary carriers to be attached to the H-shaped support in all orientations of the support relative to the vehicle 51. For example, when the H-shaped support 2 is vertical or near vertical, supplementary carriers may be attached to the then rear facing channels (41 and 43 if the long side sections 5b are above the cross member 3, or alternatively 42 and 44 if the short side member sections 5a are above the cross member 3) as shown in FIGS. 6(i), 6(ii), and 6(iv). Alternatively, when the H-shaped support 2 is horizontal or near horizontal, supplementary carriers may be attached to the then upwards facing channels (42 and 44 if the long side sections 5b are rear of the cross member 3, or 41 and 43 if the short side member sections 5a are rear of the cross member 3), as shown in FIGS. 6(iii)).

Supplementary carriers may be mounted to only a single one of the side members 5, as shown in FIGS. 6(i), 6(ii), 6(iv), and 7(i), or transversely between the two side members 5, as shown in FIGS. 6(iii), 7(ii), and 7(iii). For vehicles with a low profile trunk, such as a sedan, it is generally advantageous to carry items below the level of the trunk to minimise drag. This may be best achieved by mounting the supplementary carrier 63 transversely between the side members 5.

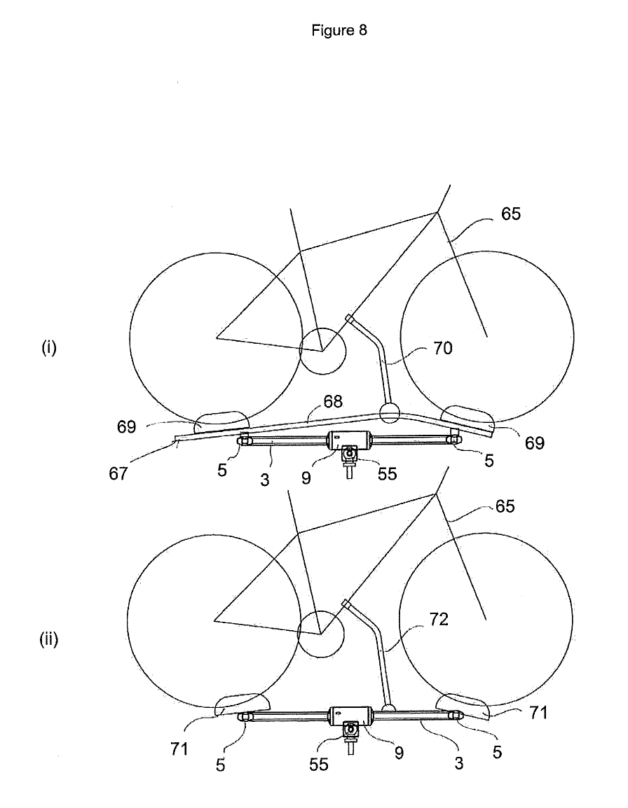

If the carrier 1 is orientated with its side members 5 horizontal, the carrier 1 can support supplementary carriers in the same manner as a roof rack with two transverse roof bars, providing a similar modular system. For example, FIG. 8(i) shows a bicycle support 67 having a main support member 68 with attached wheel supports 69 and down tube support 70, connected to the horizontally orientated carrier 1 by attaching the main support member 68 between the side members 5. The bicycle support 67 may be an existing support for use in a modular roof rack system. The profile of the side members 5 may be selected to correspond to match the profile of transverse bars on a related roof rack system such that supplementary carriers are transferable between the rear mounted carrier 1 and the related roof rack.

FIG. 8(ii) shows a further example of supporting a bicycle on the carrier 1. In that example, individual wheel supports 71 for supporting the wheels of a bicycle 65 are attached to the side members 5, and a down tube support 70 is attached to the cross member 3.

Tow-Ball Mount

FIGS. 9 to 11 show the mounting portion 37 for mounting the carrier 1 to a vehicle tow-ball 55. The mounting portion 37 comprises a housing 180 having side, top and bottom walls that receives the tow-ball 55. The housing 180 has a floor wall 1800 having an aperture 181 therein comprising an enlarged portion 181a and a narrower portion 181b.

The enlarged portion 181a of the aperture 181 has a diameter greater than the maximum diameter of the tow-ball 55, such that the housing 37 can receive the tow-ball 55 through the aperture's enlarged portion 181a. The narrower portion 181b of the aperture 181 has a width or diameter that is smaller than the maximum diameter of the tow-ball 55, such that the tow-ball 55 is unable to pass through the narrow portion 181b of the aperture 181 but larger than a diameter of the tow-ball's cylindrical supporting neck 56. The mounting portion 37 may be configured for tow-balls of varying sizes. For example, the mounting portion may be configured for use with a 1⅞ inch standard tow-ball, or for use with a 50 mm tow-ball.

To place the mounting portion 37 on a tow-ball 55, the housing 180 is placed over the tow-ball 55 so that the tow-ball 55 passes through the enlarged portion 181a of the aperture 181, and is received within the housing 180. The user then pulls the carrier 1 and mounting portion 37 rearwards, away from the vehicle 51 until the tow-ball neck 56 is positioned within the narrow portion 181b of the aperture 181 and a major part of the tow-ball 55 is positioned over the narrow aperture portion 181b. Preferably the diameter or width of the narrow aperture portion 181b substantially correspond, but is slightly larger than, the diameter of the tow-ball neck 56.

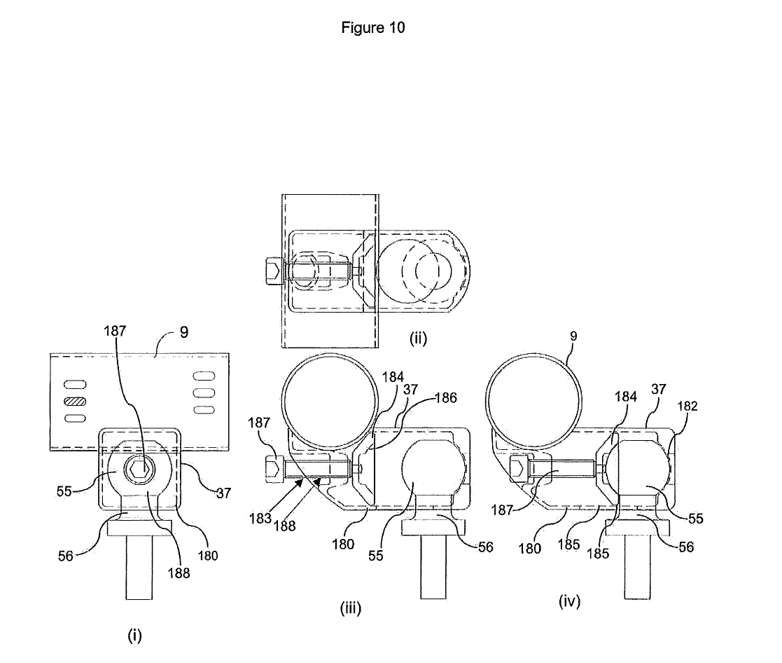

When the tow-ball neck 56 is in the narrow portion 181b of the aperture, the edge of the narrow aperture portion 181b contacts the surface of the tow-ball neck 56 as shown in FIGS. 10(i) to 10(iv).

The mounting portion 37 further comprises a clamp 183 having a jaw 184 that is linearly movable forwards and rearwards within the housing 180. The rear wall of the housing 180 comprises a recess 182 for receiving a portion of the tow-ball 55 when the tow-ball neck 56 is against the end of the narrow aperture portion 181b. The recess acts as a fixed jaw of the clamp 183, and the movable jaw is movable towards and away from the recess 182.

To adjust the position of the movable jaw 184, the movable jaw 184 is pivotally attached to the end of a threaded bolt 187 so the end of the bolt can push or pull the jaw. The bolt 187 is also received by a complementary threaded aperture 189 in a front wall of the housing 180. Rotating the bolt 187 in a first direction moves the jaw 184 linearly within the housing, towards the tow-ball 55 and recess 182 to clamp the tow-ball 55 and secure the mounting portion 37 to the vehicle 51. The front wall of the housing 180 has a recessed portion 188 containing the threaded aperture 189. The recess prevents the head of the bolt 187 from protruding outward from the housing 180 when in use.

The housing 180 is square or rectangular in cross section. The movable jaw 184 has sides 185 that are flush with the inner surface of the housing 180, to prevent rotation of the jaw 184 relative to the housing 180 as the bolt 187 is tightened.

The curvature of the recess 182 in the rear wall of the housing 180 corresponds to the curvature of the tow-ball 55 such that when the tow-ball 55 is received in the recess 182, the surface of the recess 182 is flush with the surface of the tow-ball 55. Similarly, the movable jaw 184 comprises at least one contoured surface 186 for contacting and clamping the tow-ball 55. The curvature of the contoured surface 186 corresponds to the curvature of the tow-ball 55 such that when the movable jaw 85 is moved towards the recess 182 and tightened to clamp the tow-ball 55, the contoured surface 186 is flush with the surface of the tow-ball 55.

FIG. 10(iv) shows a tow-ball 55 clamped within the mounting portion 37. In that configuration, the housing recess 182 and the contoured clamp surfaces 186 each provide a plurality of contact points (i.e. a contact area) on each jaw 182, 184 with the tow-ball 55. The multiple contact points advantageously provide a more secure connection between the mounting portion 37 and the tow-ball 55 compared to a jaw having a flat surface and therefore only a tangential contact (i.e. a contact line) with the tow-ball 55. The clamp connection of the present invention is thereby better able to resist rotation of the carrier about a vertical axis through the tow-ball 55.

The walls of the housing 180 provide vertical and lateral support to the movable jaw 184 of the clamp 183 under loading. For example, if the vehicle travels over a bump, subjecting the housing to an upward force, the wall of the housing supports the movable jaw 184 ensuring that the tow-ball remains clamped and preventing transmission of the vertical force to the clamping bolt 187 as a bending load.

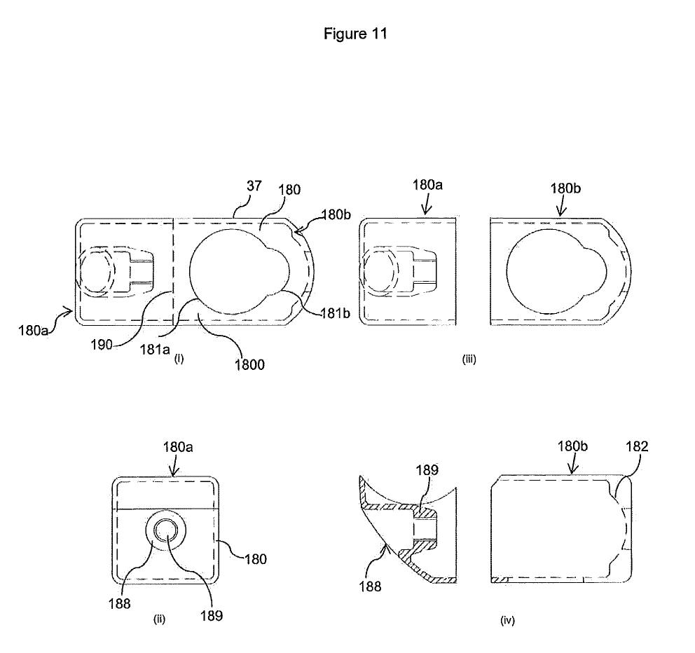

FIGS. 11(i) to (iv) show the housing 180 component parts. Preferably the housing 180 is manufactured in two parts 180a, 180b. The parts 180a, 180b may be cast, for example from steel using investment casting. To assemble the housing 180, the two housing parts 180a, 180b are welded or otherwise connected along join 190 after the movable jaw 184 has been positioned in the housing.

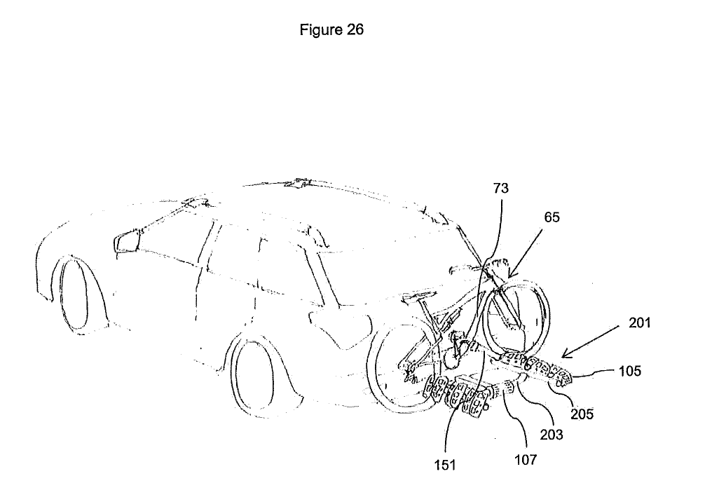

Optionally, an intermediate section (not shown) comprising a length of square hollow section may be welded or otherwise connected between the two housing parts 180a, 180b to lengthen the housing. A longer mounting portion may be required where it desirable to have the latch 7 and cross member 3 positioned further out from the rear of the vehicle, for example, for carriers similar to the one shown in FIG. 26 for supporting several bicycles. In one exemplary carrier for supporting three bicycles, the latch 7 and cross member 3 are positioned about 300 mm rear of the tow-ball to give a balanced pivot action.

The threaded bolt fastener 187 advantageously enables a high clamping force to be applied to the tow-ball 55, which also minimises movement of the mounting portion 37 relative to the tow-ball 55. Preferably the bolt can be tightened using a hex key or Allen key.

Alternative Carriers

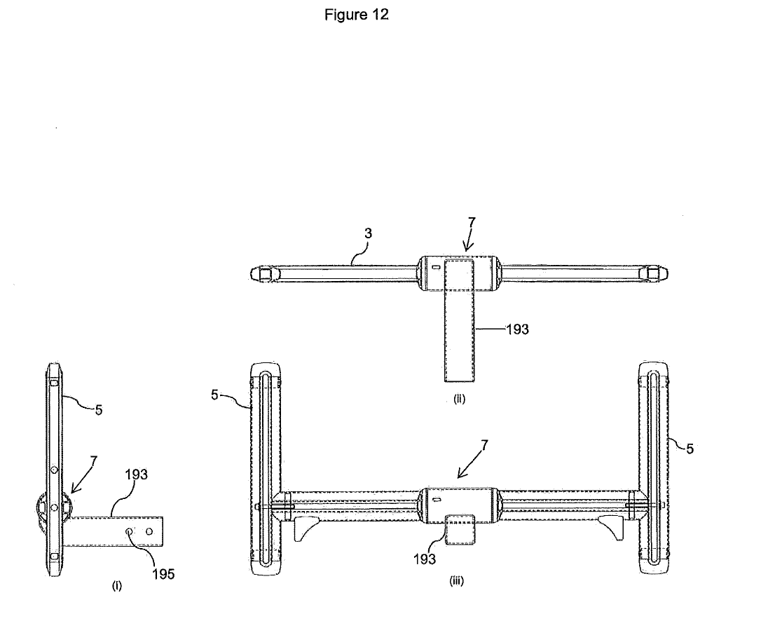

While the exemplary carrier 1 is shown having a mount portion 37 for mounting to a tow-ball, alternatively, the carrier may comprise a mounting portion for mounting to a tubular vehicle hitch. One such embodiment is illustrated in FIGS. 12(i) to 12(iii). In that embodiment, the mounting portion 37 comprises a mounting arm 193. The mounting arm has a square tubular cross section that is dimensioned to be received by a tubular hitch. The arm has at least one aperture 195 or other attachment feature for securing the arm 193 to the vehicle hitch, for example to receive a bolt or pin.

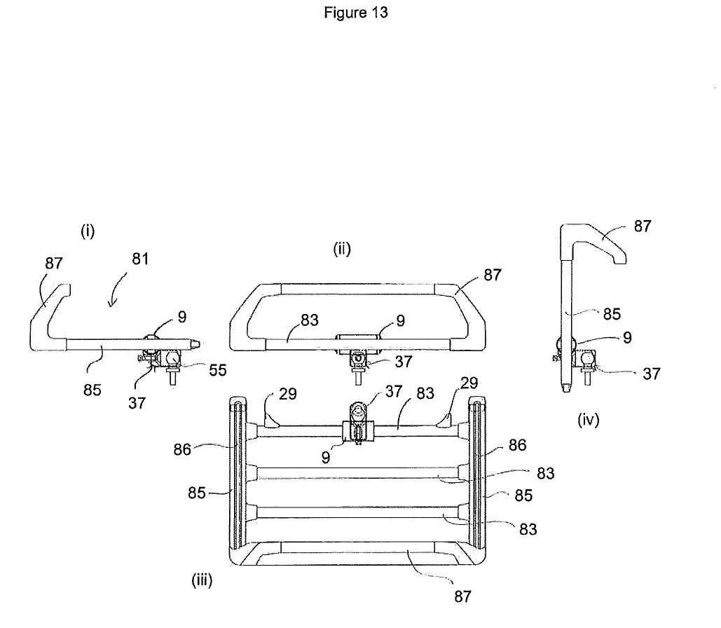

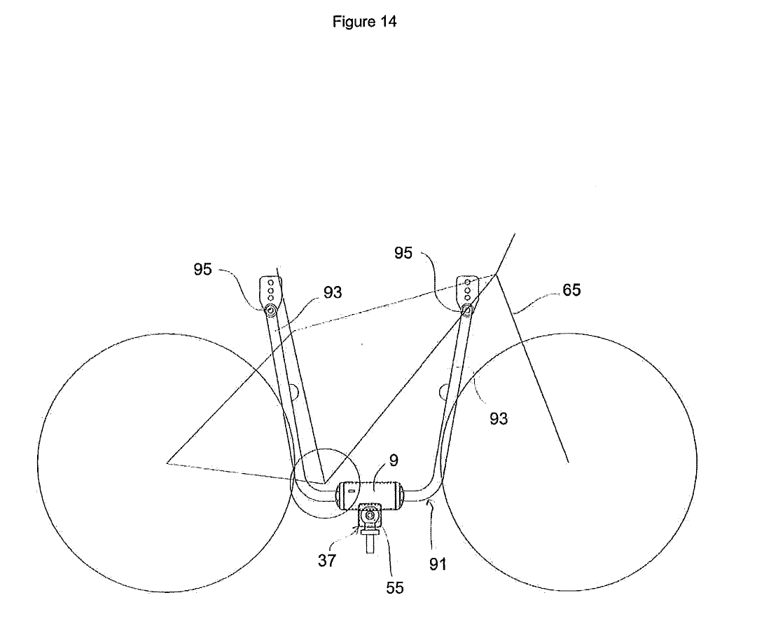

The latch mechanism 7 described above has application in a wide range of carriers for mounting to vehicles, and may be used in carriers than have only a single in-use carrying orientation to provide the advantage of rotation of the carrier to access to the rear of the vehicle or for storage. Some examples are shown in FIGS. 13(i) to 14. FIGS. 13(i) to 13(iv) show a platform type carrier with a bumper 87 that is pivotable from a horizontal in-use position shown in FIGS. 13(i) to 13(iii), to a vertical storage configuration shown in FIG. 13(iv). FIG. 14 shows a bicycle carrier 91 with two support arms 93 each having a top tube support 95 for supporting the top tube of an attached bicycle 65. The bicycle carrier 91 is pivotable away from the vehicle to enable access the rear of the vehicle.

Bicycle Carrier

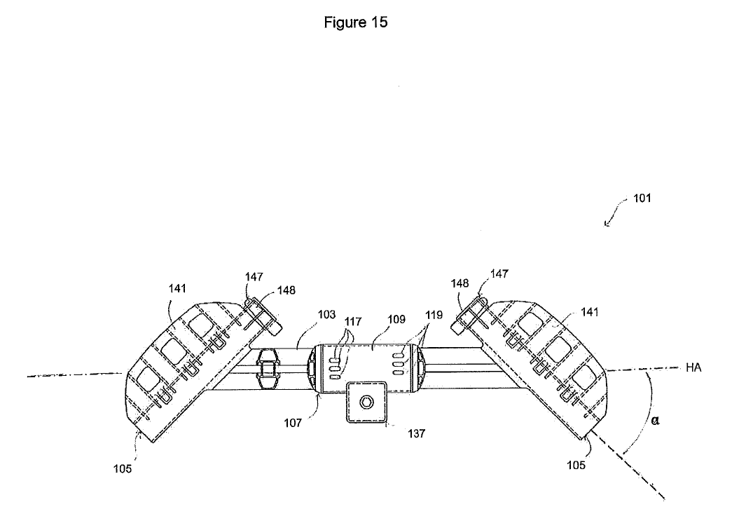

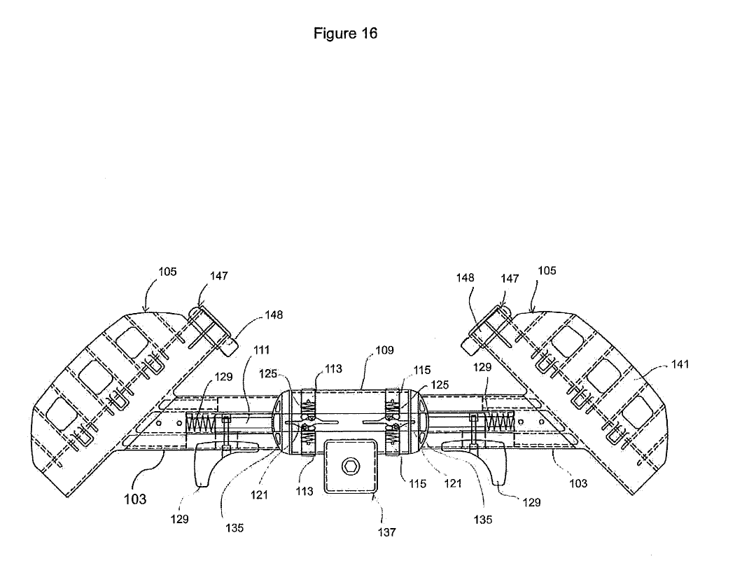

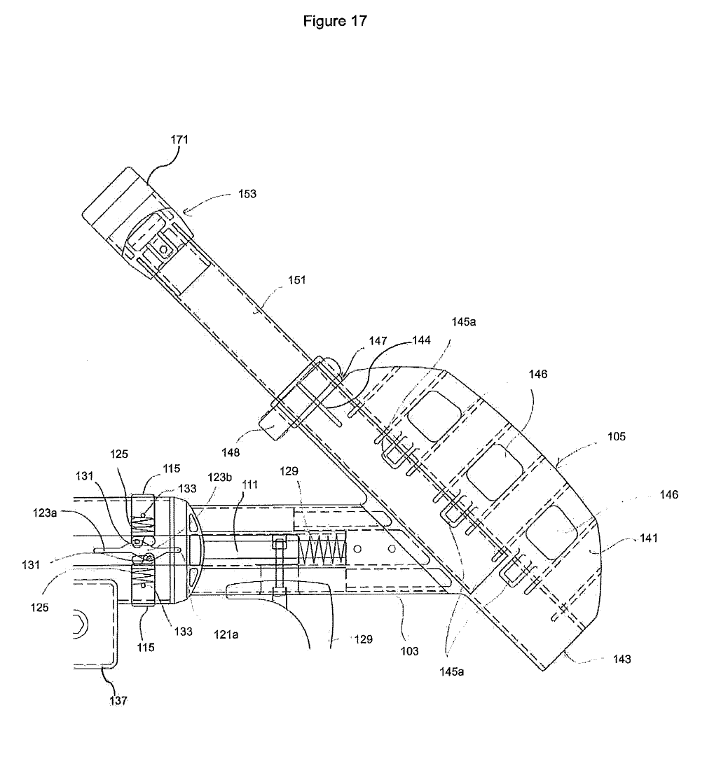

FIGS. 15 to 17 show a preferred form bicycle carrier 101. The carrier comprises a mounting portion 137 for mounting the carrier 101 to a vehicle hitch or tow-ball, and a latch adjustment mechanism 107 for adjusting the angular orientation of the carrier 101. The latch adjustment mechanism 107 is substantially as described above in relation to the latch mechanism 37 in the H-shaped carrier 1. FIGS. 16 and 17 further illustrate the components and operation of the latch mechanism 107 of the bicycle carrier 101 in FIG. 15. Like components of the latch mechanism 107 are denoted using the same reference numbers as for the latch 7 shown in FIGS. 2 to 4(ii), but with the addition of 100 to said reference number.

The bicycle carrier 101 comprises a main cross member 103 that extends through the sleeve 109 of the latch mechanism 107. The cross member 103 is rotatable relative to the sleeve 109 about a horizontal axis HA. Two angled wheel supports 105 are fixed to opposite ends of the cross member 103. The wheel supports 105 are angled inwards towards each other at an angle α to the horizontal axis HA of between about 35 degrees and about 55 degrees, preferably about 45 degrees to the horizontal axis HA, such that top ends of the wheel supports 105 are closer together than lower ends of the wheel supports 105.

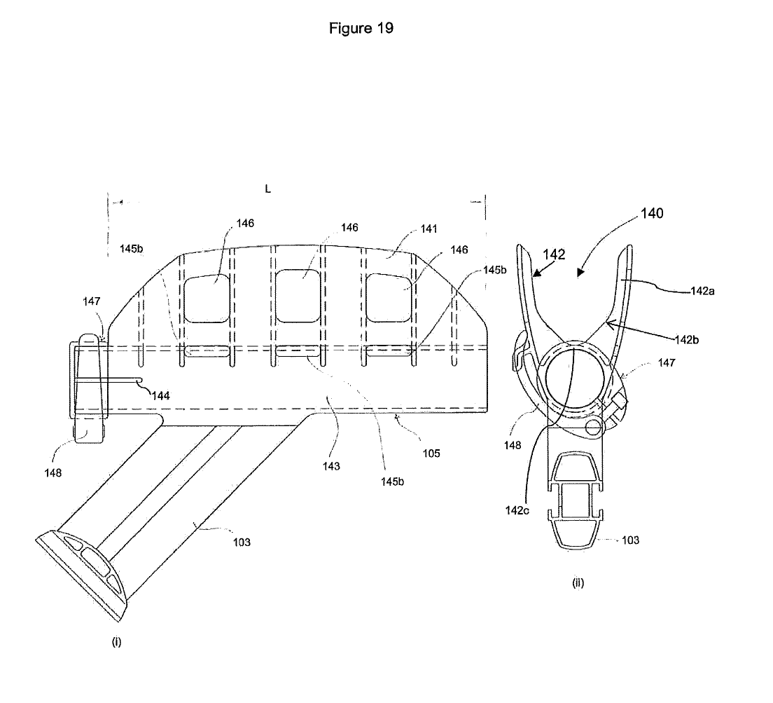

Each wheel support 105 comprises two opposed side walls 141 defining a channel contact surface 142 for receiving a portion of a bicycle wheel 66, as shown in FIGS. 19(i) to 21(iii). Bicycles 65 are supported and carried in the bicycle carrier 101 by placing one wheel 66 in each wheel support 105. The bicycle carrier 101 is pivotable from a vertical in-use configuration shown in the figures, to an angled or horizontal configuration (not shown) using the latch adjustment mechanism 107 in the same manner as described above. For example, the bicycle carrier 101 may be pivoted away from the vehicle (not shown) while bicycles 65 are supported by the carrier 101, to provide access to the rear of the vehicle.

The bicycle carrier 101 may be transported in an angled orientation. For example, to lean bicycles towards a vehicle with a sloping rear, so the bicycles are substantially parallel with the rear of the vehicle.

The angle and length L of the wheel supports 105 enables the bicycle carrier 101 to support bicycles 65 of different geometries. For example, the carrier 101 is suitable for supporting bicycles with a range of different wheel bases or different wheel diameters. The wheels of bicycles with shorter wheel bases are supported higher in the wheel support channels 140 than bicycles with longer wheel bases.

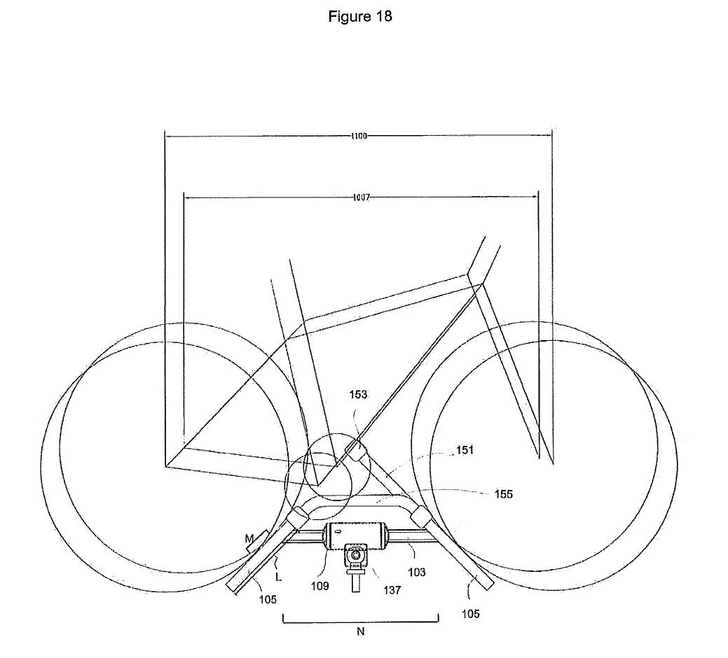

FIG. 18 shows a schematic comparison between a bicycle with a 1100 mm wheel base and a bicycle with a 1007 mm wheel base. The contact point CP2 between the wheels and the respective wheel support 105 for the bicycle with a 1007 mm wheel base is about 78.8 mm higher than the contact points CP1 for the larger bicycle. Similarly, the contact point would be lower for a bicycle with the same wheel base but smaller diameter wheels. In FIG. 18 the wheel supports have a length L of 200 mm. However, L could be about 100 mm as shown by M or up to about 300 mm (not shown). The distance N is 600 mm and represents the distance between the mid point of each wheel support in the embodiment depicted in FIG. 19. Although, it should be appreciated that the distance N could be about 400 mm to about 700 mm and still accommodate bicycles having different wheel bases as shown. The angle of the wheel supports 105 in FIG. 18 is 45° to the horizontal.

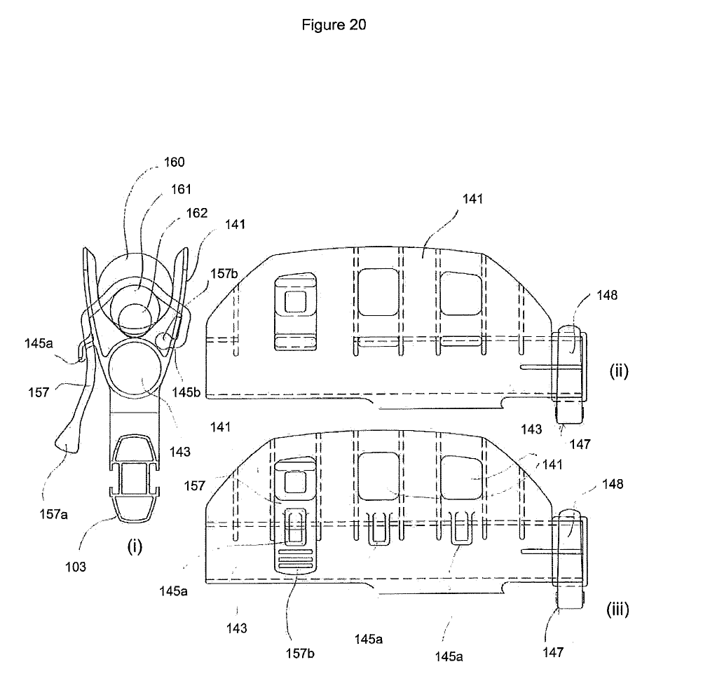

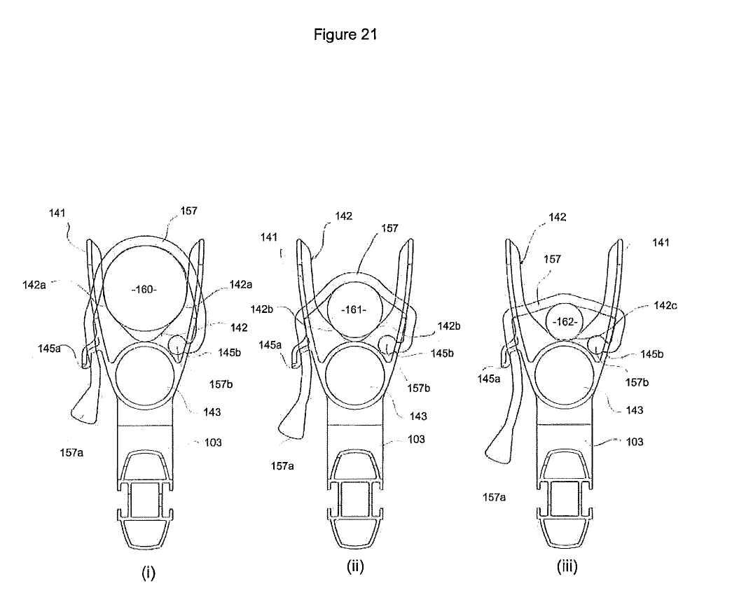

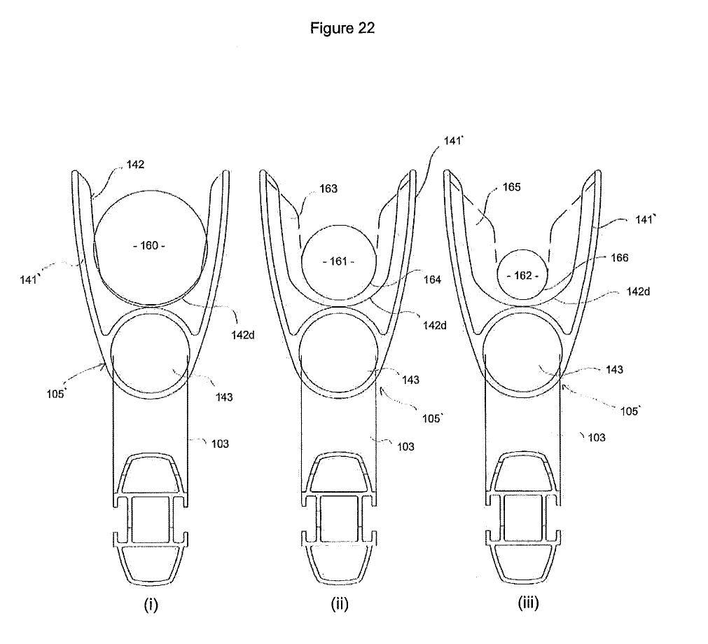

The inner contact surface 142 of the channel has a curvature and width that corresponds to the curvature and width of at least one type of bicycle tyre. FIGS. 19(i) to 21(iii) illustrate a preferred form wheel support 105. In that support, the curvature of the channel contact surface 142 changes from the base of the channel to the top of the channel, to support different width bicycle tyres 160, 161, 162 at different parts of the channel 140—refer FIG. 20(i). In the embodiment shown, the channel contact surface 142 has three support portions 142a, 142b, 142c with differing curvatures for supporting tyres and wheel rims of different widths. A base portion 142c of the channel has the highest curvature, an intermediate portion 142b, and an upper portion 142a of the channel having respectively lower curvature than the base portion 142c. FIGS. 21(i) and 22(i) to 22(iii) illustrate three different size tyres 160, 161, 162 supported in the channel 142.

In the embodiment shown, the base support portion 142c has an arc radius that corresponds to the curvature of a typical 23 mm wide road bicycle tyre, such that when a road bicycle wheel is placed in the wheel support 105, the tyre 162 will be supported in the base portion 142c of the channel and a lower surface of the tyre 162 will be cradled by the surface of the base portion 142c.

The upper wall portion 142a has an arc radius that corresponds to the curvature of a 45 to 60 mm wide mountain bike tyre 160, such that when a mountain bike tyre 160 is placed in the wheel support 105, the tyre is supported by the walls of the upper support portion 142a of the channel. As shown in FIG. 21(i), two lower surfaces of the tyre 160 will be cradled by opposite surfaces of the upper portion 142b.

The intermediate support portion 142b is shaped to support a 25 to 28 mm wide touring or commuting bicycle tyre such that when a wheel with a 25 to 28 mm wide tyre 161 is placed in the wheel support 105, the tyre is supported by the walls of the intermediate portion 142b of the channel, as shown in FIG. 21(ii), with two lower surfaces of the tyre 161 supported by opposite surfaces of the intermediate portion 142b.

The walls 141 of the wheel supports 105 extend above the upper support portion 142a to provide additional side supports, such that when a mountain bike wheel or other wide-rim wheel is placed in the wheel support, the walls 141 extend above the top of the cross section of the tyre, as shown in FIG. 21(i). Preferably the walls 141 extend sufficiently above the upper seat portion 142a to provide lateral support to the wheels to prevent the wheels coming out of the wheel supports under lateral loading or from bouncing out as a result of vertical movement of the carrier.

An alternative embodiment wheel support 105′ is shown in FIGS. 22(i) to 22(iii). In that embodiment, a lower portion 140 of the wheel support channel 142 has a radius of curvature corresponding to the curvature of a mountain bike tyre 160. Tyres 160 of mountain bike wheels placed in the wheel support 105′ will be positioned in the lower part of the channel such that a lower surface of the mountain bike tyre 160 is cradled by support portion 142d.

To support wheels with narrower tyres 161, 162, inserts 163, 165 specific to the wheel type may be placed in the channel 142′. FIG. 22(ii) shows an insert 163 for a medium width touring or commuting bicycle tyre 161. The insert 163 has a support portion 164 with a curvature corresponding to the curvature of a 25-28 mm wide tyre 161 such that the tyres of touring or commuting bicycle wheels placed in the wheel support 105′ will be positioned in the lower part of the insert with a lower surface of the tyre 161 cradled by support portion 164. As a further example, FIG. 22(iii) shows an insert 165 for a road bicycle tyre. The insert 165 has a support portion 166 with a radius of curvature of about 12.5 mm corresponding to a standard 23 mm wide road bicycle tyre, such that road bicycle wheels placed in the wheel supports 105 will be positioned in the lower part of the insert 165 with the lower surface of the tyre 162 cradled by the curved support portion 164.

The inserts 163, 165 may comprise a foamed elastomer such as EVA, or another suitable material.

Both of the wheel support embodiments 105, 105′ shown in FIGS. 20(i) to 22(iii) provide a curved support surface that provides a contact surface area or multiple contact points between a bicycle tyre and the wheel support 105, 105′. This in turn centres the tyre in the channel 140 to prevent or minimise lateral movement of the wheel. In combination with the 35 to 55 degree angle of the wheel supports 105, 105′, this advantageously enables bicycles 65 with their wheels 66 placed in the wheel supports 105, 105′ to be freestanding without the need for additional support, at least during loading or unloading of the bicycle. In contrast, a flat support surface would provide only a single tangential contact point with the tyre 160, 161, 162 rather than a multi-point or surface contact, and would not provide the same lateral support to the bicycle wheel to enable the bicycle to be freestanding.

Each wheel support 105, 105′ may have a strap 157 for securing bicycle wheels 160, 162, 162 in the wheel supports. FIGS. 21(i) to 21(iii) show wheels with the different sized tyres secured in the wheel support 105 with an attachment strap 157.

The strap 157 may be removably secured to the respective wheel support 105 using a hook and aperture arrangement. The wheel supports 105 comprise three apertures 145b in one of the side walls 141 for receiving a strap 157(see FIG. 20(ii)). The opposite side wall 141 comprises three corresponding hooks 145a (FIG. 20(iii)). The attachment strap 157 has an enlarged end portion 157b that is larger than the aperture 145b and cannot pass through the aperture. To attach the strap 157 to the respective wheel support 105, the strap 157 may be threaded through any one of the three apertures 145b, depending on the position of the wheel along the wheel support 105. The enlarged end portion 157b of the strap prevents the strap 157 being pulled through the aperture 145b.

The strap 157 preferably comprises an elastomeric material and a plurality of apertures. To secure the wheel in the wheel support 105, the strap 157 is stretched over the wheel rim and tyre 160, 161, 162 and secured by engaging the hook 145a with one of the apertures. Different apertures will be engaged depending on the size of the wheel rim and tyre. FIGS. 21(i) to 21(iii) show the strap adjusted to different lengths to hold the differently sized wheels 160, 162, 162 in the wheel support 105.

As shown in FIG. 17, the bicycle carrier 101 further comprises an adjustable support arm 151 for attaching to the down tube 73 of a bicycle 65 for additional stability of the bicycle during transport. The support arm 151 extends telescopically from a corresponding tubular receiver 143 in at least one of the wheel supports 105 and is movable in a longitudinal direction of the support arm 151 to adjust the length of support arm 151 protruding from the receiver 143 to accommodate bikes of different sizes and geometries.

The support arm 151 preferably extends from the wheel support 105 at the same angle α as the wheel support 105 angle to the horizontal axis HA, and preferably at about 45 degrees to the horizontal axis HA.

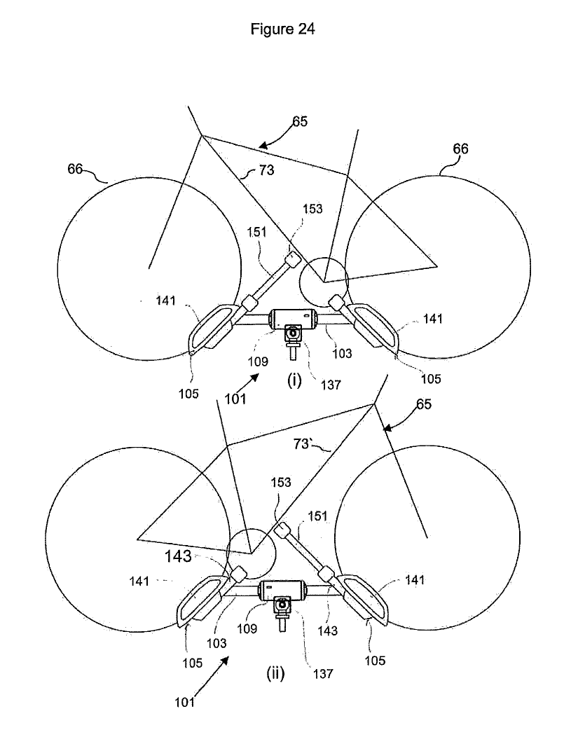

In the embodiment shown, both wheel supports 105 comprise a receiver 143 for the down tube support arm 151. The support arm 151 may be placed in either receiver 143 and can be removed from one receiver 143 and placed in the other receiver 143 to support an oppositely oriented bike. FIGS. 24(i) and 24(ii) show the support arm 151 placed in the receiver 143 of the left wheel support 105 for a bicycle facing left, and in the receiver 143 on the right wheel support 105 to support a bicycle facing right.

The top of each receiver 143 comprises a collar 147 with a cam lever 148 that can be tightened to fix the position of the down tube support arm 151 relative to the wheel support 105, or loosened to allow adjustment, removal, or entry of the down tube support arm 151 in the receiver 143. The top of the receiver 143 has a slot 144 (FIGS. 17, 19(i)) to enable the diameter of the receiver 143 to be narrowed. Closing the cam lever 148 as shown in FIG. 19(ii) squeezes the slot 144 closed to clamp the down tube support arm 151 and fix the position of the support arm 151 relative to the wheel support 105.

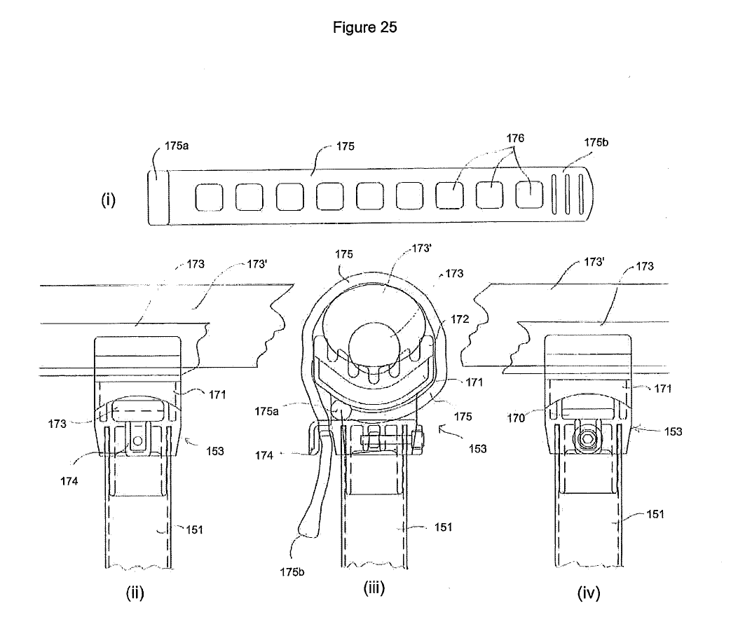

The top of the adjustable down tube support arm 151 comprises an attachment 153 for securing to the down tube 173, 173′ of a bicycle. The attachment 153 shown in FIGS. 25(i) to 25(iv) comprises a cradle 171 that receives the down tube 173, 173′. The cradle 171 is preferably shaped to receive a range of differently sized or shaped down tubes 73, 73′ and may have a cushioned portion 172 to prevent damage to the down tube, and to better accommodate and distribute loading on differently shaped down tubes 173, 173′.

The attachment 153 further comprises strap 175 and hook 174 arrangement similar to wheel support strap 157. The attachment portion 153 has an aperture 170 for receiving the strap 175. The strap 175 has an enlarged end portion 175a that is larger than the aperture. The strap 175 is threaded through the aperture 170, with the strap enlarged end portion 175a limiting movement of the strap 175 through the aperture 173. The strap 175 preferably comprises an elastomeric material and a plurality of apertures 176 such that the strap 175 can be stretched over the down tube 173, 173′ and secured by pulling a free end 175b of the strap down and engaging the hook 174 with one of the apertures 176, as shown in FIG. 25(iii).

The bicycle carrier 101 may comprise a single pair of wheel supports 105 for supporting a single bicycle, or alternatively may comprises two or more pairs of wheel supports 105 for supporting a plurality of bicycles 65. FIG. 26 shows a bicycle carrier 201 for supporting three bicycles. That bicycle carrier 201 comprises a main member comprising a cross member 203, and two parallel side members 205. One angled wheel support 105 in each pair is fixed to each side member 205. The wheel support pairs are substantially parallel with each other such that bicycles placed side-by-side on the carrier 201 will also be substantially parallel with each other.

One bicycle 65 may be mounted in each pair of wheel supports 105, with the down tube 73 supported by a respective down tube support arm 151. To fit three bicycles side-by-side, the bicycle supported on the middle wheel support is preferably arranged to face in the opposite direction to the bicycles placed in the front and rear wheel support pairs to accommodate the bicycle handle bars. The down tube support arm 151 in the central wheel support pair would accordingly extend from the opposite side wheel support to the front and rear wheel support pairs.

The length L of each wheel support portion 105 also provides advantages for placing bicycles of varying sizes side-by-side. For example, it is not necessary for each bike to be centred exactly in each wheel support pair, with the height of the contact point between the bicycle front wheel and the respective wheel support at the same height as the contact point between the bicycle rear wheel and its respective wheel support. Instead, a bicycle may be arranged with its rear wheel supported higher than its front wheel, or with its front wheel supported higher than its rear wheel. This may be advantageous to prevent the handlebars of one bicycle clashing with the handlebars, seat, or frame of an adjacent bicycle.

A multi bicycle carrier 201 may comprise a latch mechanism 107 as described above to enable pivoting and angular adjustment of the carrier 201.

Preferred embodiments of the invention have been described by way of example only and modifications may be made thereto without departing from the scope of the invention.

1. A bicycle carrier for mounting to a vehicle, the carrier comprising:
a mounting portion for attaching the carrier to a vehicle;
a main member attached to the mounting portion; and
a pair of wheel supports fixed relative to the main member and at an angle of between about 35 degrees and about 55 degrees to a substantially horizontal axis, such that upper ends of the wheel supports are closer together than lower ends of the wheel supports, so that collectively the pair of wheel supports are angled inwards towards each other to form a rotational angle therebetween of about substantially 70-110 degrees;
wherein each wheel support comprises a channel for partial receipt of a bicycle wheel, and wherein the wheel supports includes a curved support surface for providing a contact surface between the bicycle tire and the wheel support to frictionally support the wheels of bicycles having a range of wheel diameters and/or wheel base lengths.

2. A bicycle carrier as claimed in claim 1, wherein the wheel supports are fixed relative to the main member at an angle of about 45 degrees to the substantially horizontal axis.

3. A bicycle carrier as claimed in claim 1, wherein a portion of each wheel support channel has a cross-sectional curvature corresponding to the curvature of a first selected bicycle tire and dimensioned to frictionally contact the first selected bicycle tire.

4. A bicycle carrier as claimed in claim 3, wherein each wheel support comprises a removable insert defining a channel with a cross-sectional curvature corresponding to the curvature of a second selected bicycle tire that is narrower than the first selected bicycle tire and dimensioned to frictionally contact the second selected bicycle tire.

5. A bicycle carrier as claimed in claim 3, wherein the base portion of each wheel support channel has a cross sectional radius of curvature of between about 10 mm and about 12 mm, and an upper portion of each wheel support channel has a cross sectional curvature of between about 20 mm and about 30 mm.

6-18. (canceled)

19. A bicycle carrier for mounting to a vehicle, the carrier comprising:
a mounting portion for attaching the carrier to a vehicle;
a main member attached to the mounting portion; and
a pair of wheel supports fixed relative to the main member and at an angle of between about 35 degrees and about 55 degrees to a substantially horizontal axis, such that upper ends of the wheel supports are closer together than lower ends of the wheel supports, so that collectively the pair of wheel supports are angled inwards towards each other to form a rotational angle therebetween of about substantially 70-110 degrees;
wherein each wheel support comprises two opposed side walls defining a channel contact surface, for receiving a portion of a bicycle wheel, and wherein the channel support surface has three support portions with different curvatures, for supporting tires and wheel rims of different widths.

20. A bicycle carrier as claimed in claim 2, wherein a portion of each wheel support channel has a cross-sectional curvature corresponding to the curvature of a first selected bicycle tire and dimensioned to frictionally contact the first selected bicycle tire.
